(19) United States
(12) Patent Application Publication
(10) Pub. No.: US 2025/0203706 A1
(43) Pub. Date: Jun. 19, 2025

(54) METHOD AND APPARATUS FOR NETWORK ENERGY SAVING WITH USER EQUIPMENT DATA SCHEDULING

(71) Applicant: MEDIATEK INC., Hsinchu City (TW)

(72) Inventors: Wei-De WU, Hsinchu City (TW); Chien-Chun CHENG, Hsinchu City (TW); Cheng-Hsun LI, Hsinchu City (TW); Yi-Ju LIAO, Hsinchu City (TW)

(21) Appl. No.: 18/843,016

(22) PCT Filed: Mar. 30, 2023
(86) PCT No.: PCT/CN2023/085223

§ 371 Date: Aug. 30, 2024

Related U.S. Application Data
(60) Provisional application No. 63/325,167, filed on Mar. 30, 2022.

(51) Int. Cl. H04W 76/28; H04W 48/12; H04W 52/02

(52) U.S. Cl. CPC H04W 76/28; H04W 48/12; H04W 52/0248

(57) ABSTRACT

Various solutions for improvement of network energy saving with user equipment data scheduling are described. An apparatus may receive a system information block (SIB) from a network node of a wireless network. The SIB indicates at least one cell-specific discontinuous reception (DRX) parameter set. The apparatus may determine one of the at least one cell-specific DRX parameter set based on the SIB. The apparatus may apply the one of the at least one cell-specific DRX parameter set to a DRX procedure.

### CROSS REFERENCE TO RELATED PATENT APPLICATION(S)

The present disclosure claims the priority benefit of U.S. Provisional Patent Application No. 63/325,167, filed on 30 Mar. 2022. The contents of aforementioned applications are herein incorporated by reference in their entirety.

### TECHNICAL FIELD

The present disclosure is generally related to mobile communications and, more particularly, to improvement of network energy saving with user equipment (UE) data scheduling.

### BACKGROUND

Unless otherwise indicated herein, approaches described in this section are not prior art to the claims listed below and are not admitted as prior art by inclusion in this section.

For current network implementations, one base station (BS) may be configured with an energy saving mechanism, which can trigger the BS to transit into a sleep mode/power saving mode (e.g., SM1˜SM4 depending on traffic, cycles/periodicities, and default settings, etc.) when the BS has no or low transmission/activity with one or more user equipments (UEs). However, during UE switching from one BS to another BS, the present energy saving mechanism for the BS is not efficient enough when the BS serves the active UE(s). In addition, it is import for the UE to balance user experiences as well as optimized transmission to the BS when the BS applies the energy saving mechanism.

Accordingly, how to improve network energy saving with UE data scheduling and efficiently cooperate with UE(s) for minimum tradeoff/impacts becomes an important issue for the newly developed wireless communication network. Therefore, there is a need to provide proper energy-saving schemes to adapt the network configurations for various traffic scenarios.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to improvement of network energy saving with UE data scheduling.

In one aspect, a method may involve an apparatus receiving a system information block (SIB) from a network node of a wireless network. The SIB indicates at least one cell-specific discontinuous reception (DRX) parameter set. The method may also involve the apparatus determining one of the at least one cell-specific DRX parameter set based on the SIB. The method may further involve the apparatus applying the one of the at least one cell-specific DRX parameter set to a DRX procedure.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a SIB from the network node. The SIB indicates at least one cell-specific DRX parameter set. The processor may also perform operations comprising determining one of the at least one cell-specific DRX parameter set based on the SIB. The processor may further perform operations comprising applying the one of the at least one cell-specific DRX parameter set to a DRX procedure.

In one aspect, a method may involve a network node configuring at least one cell-specific DRX parameter set in a SIB. The method may also involve the network node transmitting the SIB to an apparatus of a wireless network.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of DRX operations in accordance with the present disclosure.

FIG. 2 is a diagram depicting an example scenario showing issues in accordance with the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement of network energy saving with UE data scheduling. According to the present disclosure, a number of possible solutions may be implemented separately or jointly. That is, although these possible solutions may be described below separately, two or more of these possible solutions may be implemented in one combination or another.

In 3^{rd} Generation Partnership Project (3GPP), a radio access network (e.g., 5G NR access network) may include a plurality of base stations (BSs) (e.g., Next Generation Node-Bs (gNBs)) to communicate with a plurality of mobile stations referred as UEs. Based on current network implementations, the BS may be configured with an energy saving mechanism, which can trigger the BS to transit into a sleep mode/power saving mode (e.g., SM1-SM4 depending on traffic, cycles/periodicities, and default settings, etc.) when the BS has no or low transmission/activity with one or more UEs. In one example, transmission/activity between the UE and the BS may be a bursting traffic (e.g., a video stream), a sparse and light traffic (e.g., an instant message), or a frequent traffic (e.g., a voice over Internet Protocol (VoIP)). Based on different types of traffic, the BS may be adaptively configured with different sleep modes, and the UE may be configured with corresponding operations, e.g., a DRX technique, for adaptive transmission with less power consumption. In DRX operations, the UE may perform wireless reception in a DRX ON duration, and switch to a power saving mode in a DRX OFF duration since the network will not transmit any data to the UE in the DRX OFF duration.

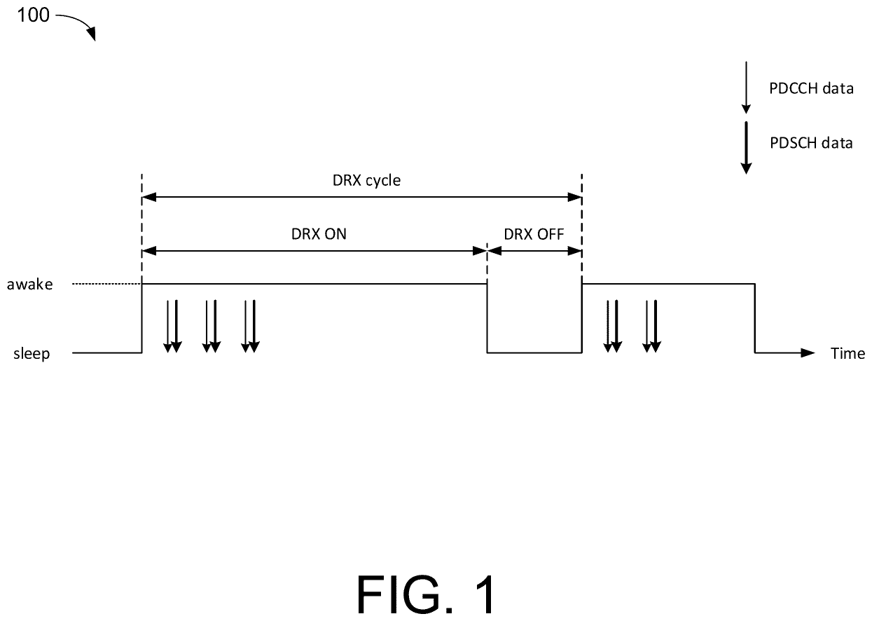

FIG. 1 illustrates an example scenario 100 of DRX operations in accordance with the present disclosure. Specifically, the DRX active time may refer to a period of time in which a UE is awake and be determined based on at least one parameter configured by a DRX parameter set from the BS (e.g., a gNB/TRP). In one example, the DRX parameter set may include, but not limited to, at least one of a DRX offset, a DRX cycle, a DRX ON duration timer, DRX inactivity timer, and DRX retransmission timer, etc. As shown in scenario 100, the UE wakes up at a beginning of the DRX ON duration of each DRX cycle, and stays awake to monitor the PDCCH and receive downlink (DL) data packets, including PDCCH data packets and PDSCH data packets. However, during the transmission/activity between the BS and the UE for different types of traffic, there are still some improvements for applying the energy saving mechanism, especially for the frequent traffic as the VoTP.

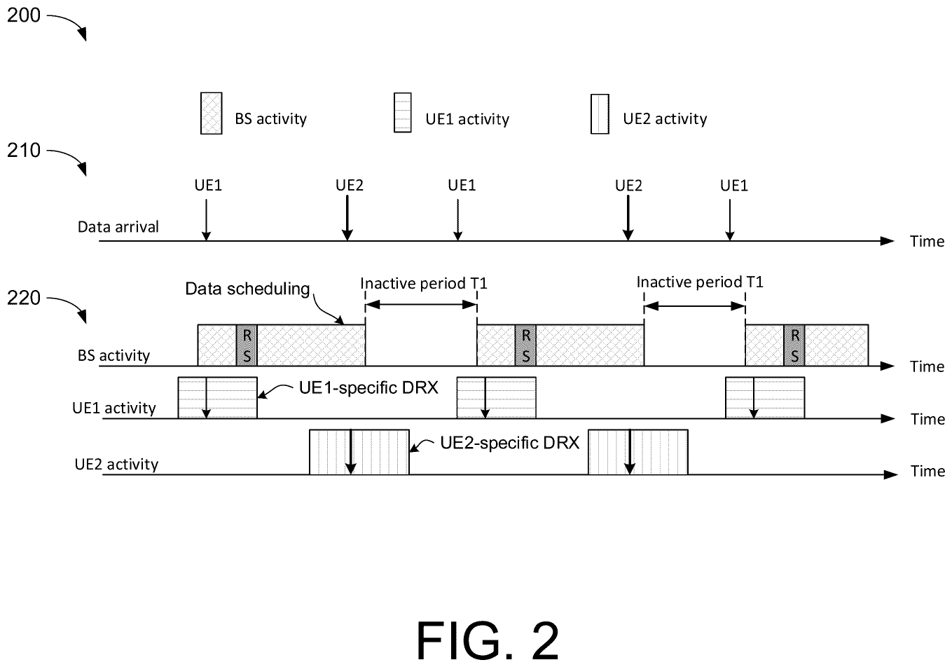

FIG. 2 illustrates an example scenario 200 showing issues in accordance with the present disclosure. As shown in scenario 200, the radio access network includes at least one BS serving two UEs (e.g., a UE1 and a UE2) and provides services for a frequent traffic (e.g., the VoIP). In diagram 210, it is assumed that the UE1 and the UE2 may periodically receive DL data in sequential time domain. In diagram 220, the BS may be periodically activated in a period of data scheduling with a transmission of reference signal (RS). In addition, the UE1 and the UE2 may be configured with different DRX procedures that have different UE-specific DRX parameters for corresponding activities. In one example, the UE1 is configured with a UE1-specific DRX parameter to perform its reception (i.e., a UE1 activity), and the UE2 is configured with a UE2-specific DRX parameter to perform its reception (i.e., a UE2 activity). Although the frequent traffic only requires a short period for the UE1/UE2 to receive DL data from the BS, the BS has to be activated for a long period (e.g., a period of the data scheduling) due to the misalignment between different activation periods of UEs configured by different UE-specific DRX parameters, which remains a shorter inactive period T1 between two adjacent data scheduling for the BS to switch into a sleep mode and results in a poor network energy saving of the BS.

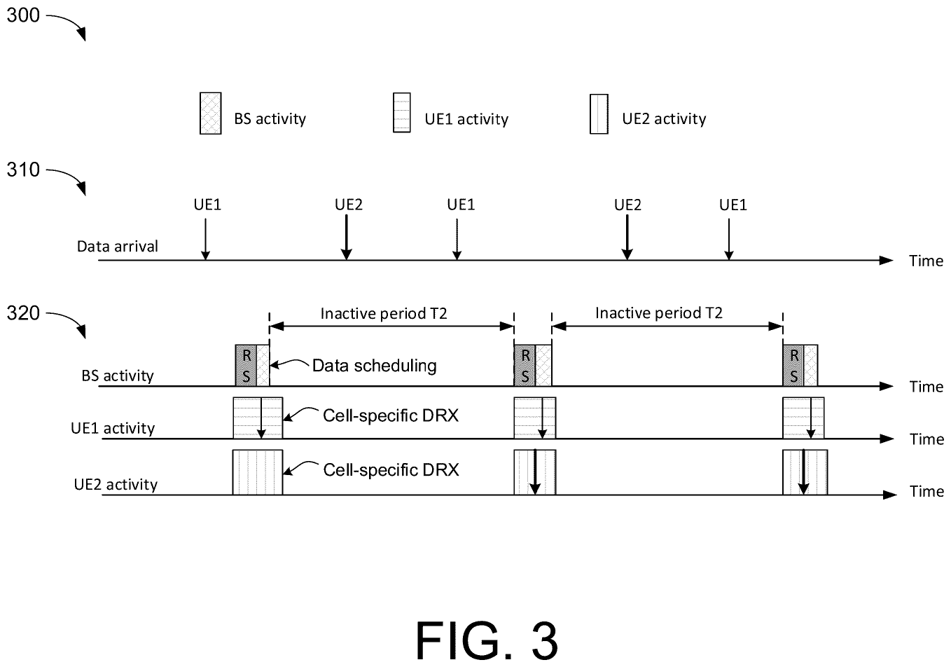

FIG. 3 illustrates an example scenario 300 under schemes in accordance with implementations of the present disclosure. As shown in scenario 300, the radio access network is similar to the one depicted in scenario 200. A novel aggregation mechanism is applied to the BS. In diagram 310, it applies the same scenario shown in diagram 210 (i.e., the UE1 and the UE2 periodically receive DL data in sequential time domain). After applying the aggregation mechanism, as shown in diagram 320, the BS may configure at least one cell-specific DRX parameter set in an SIB and broadcast the SIB UE(s) (e.g., the UE1 and the UE2). In one example, the cell-specific DRX parameter set may include at least one parameter indicating a DRX offset. After receiving the SIB from the BS, the UE(s) (e.g., the UE1 and the UE2) may determine to apply the same parameter indicated by one of the at least one cell-specific DRX parameter set (e.g., the DRX offset from the one of the at least cell-specific DRX parameter set) for activity alignment. In one example, as shown in diagram 320, the UE1 and the UE2 may apply the same cell-specific DRX to align their activities (i.e., the UE1 activity and the UE2 activity) and the BS may also align a RS transmission with the UE1/UE2 activity. As that, a DRX active time of the UE1/UE2 activity is aligned with a cell-specific RS time of the RS transmission, where the DRX active time represents a transmission/activity period of the UE1/UE2 with the BS. When implementing the frequent traffic with the aggregation mechanism, the BS only needs to be activated for a shorter period due to the aligned transmission/activity of the BS and the UE(s). In comparison with the inactive period T1 in diagram 220, an inactive period T2 between two adjacent data scheduling in diagram 320 is much longer, and the BS can adaptively switch into a sleep mode with the longer inactive period T2 and realize better network energy savings.

In some implementations, the BS may configure an indication in the SIB. After receiving the indication indicated by the SIB, the UE(s) may adaptively determine and apply/activate the one of the at least one cell-specific DRX parameter set based on the indication for its configured DRX procedure.

In some implementations, since it is import for the UE to balance user experiences as well as optimized transmission to the BS when the BS applies the energy saving mechanism, an adaptation mechanism may be applied to the BS for different traffics. In one example, the BS may configure an adaptation in a system information update procedure to the UE(s), where the adaptation can adapt and change the indication configured by the SIB. Based on different traffics with different transmission patterns/qualities, the BS may conditionally broadcast the adaptation by the SIB to the UE(s). The UE(s) may adaptively determine and apply one parameter from the one of the at least one cell-specific DRX parameter set to its corresponding DRX procedure according to the adaptation.

In some implementations, the BS may configure the indication/adaptation via a layer 1 (L1) signaling to the UE(s). The UE(s) may adaptively determine and apply the one of the at least one cell-specific DRX parameter set based on the indication for the DRX procedure. In one example, the L1 signaling may include at least one of an extended Downlink Control Information (DCI) format 2_7, an extended paging DCI, an extended primary synchronization signal (PSS), an extended secondary synchronization signal (SSS), and an extended periodic-tracking reference signal (periodic-TRS).

In some implementations, the UE(s) may adaptively apply the adaptation according to an application delay, so as to determine and apply the one of the at least one cell-specific DRX parameter set for the DRX procedure. After receiving the indication or the adaptation, the UE(s) may wait for a period of time (i.e., the application delay) and start to apply the one of the at least one cell-specific DRX parameter set after the application delay.

### Illustrative Implementations

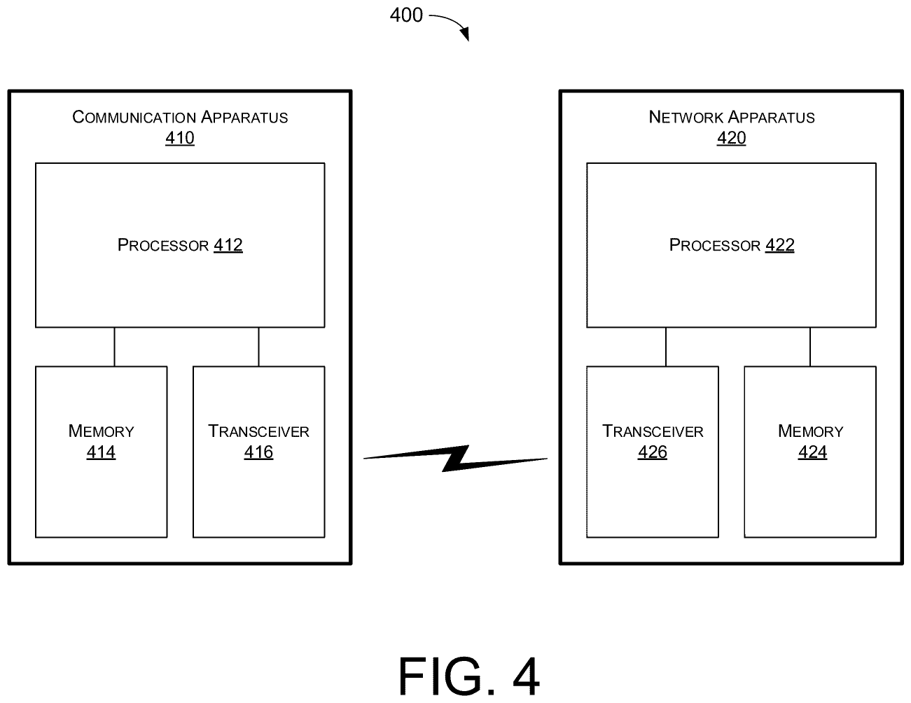

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to improvement of network energy saving with UEs, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network or in a gNB in a 5G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including autonomous reliability enhancements in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may receive, via transceiver 416, a SIB from the network apparatus 420, wherein the SIB indicates at least one cell-specific DRX parameter set. Then, processor 412 may determine one of the at least one cell-specific DRX parameter set based on the SIB. Then, processor 412 may apply the one of the at least one cell-specific DRX parameter set to a DRX procedure.

In some implementations, processor 412 may align a DRX active time with a cell-specific RS time based on a DRX offset. The DRX offset may be configured by the one of the at least one cell-specific DRX parameter set.

In some implementations, the aligning of the DRX active time with the cell-specific RS time based on the DRX offset may correspond to an aggregation of activities of network apparatus 420.

In some implementations, processor 412 may obtain an indication configured by the SIB. Processor 412 may determine the one of the at least one cell-specific DRX parameter set based on the indication.

In some implementations, processor 412 may receive, via transceiver 416, an adaptation configured by a system information update procedure form network apparatus 420. Processor 412 may adapt the indication based on the adaptation to determine the one of the at least one cell-specific DRX parameter set.

In some implementations, processor 412 may obtain an indication and an adaptation configured by an L1 signaling. Processor 412 may determine the one of the at least one cell-specific DRX parameter set based on the indication and the adaptation.

In some implementations, the L1 signaling may comprise at least one of an extended DCI format 2_7, an extended paging DCI, an extended PSS, an extended SSS, and an extended periodic-TRS.

In some implementations, processor 412 may apply the adaptation according to an application delay.

In some implementations, processor 422 may configure at least one cell-specific DRX parameter set in a SIB. Then, processor 422 may transmit, via transceiver 426, the SIB to the communication apparatus 410.

In some implementations, processor 422 may align a DRX active time with a cell-specific RS time based on a DRX offset. The DRX offset may be indicated by the one of the at least one cell-specific DRX parameter set.

In some implementations, processor 422 may configure an indication in the SIB to the apparatus. Processor 422 may configure an adaptation with a system information update procedure to communication apparatus 410. The adaptation may adapt the indication in the SIB.

In some implementations, processor 422 may configure an indication and an adaptation in an L1 signaling to communication apparatus 410. The L1 signaling may comprise at least one of an extended DCI format 2_7, an extended paging DCI, an extended PSS, an extended SSS, and an extended periodic-TRS.

### Illustrative Processes

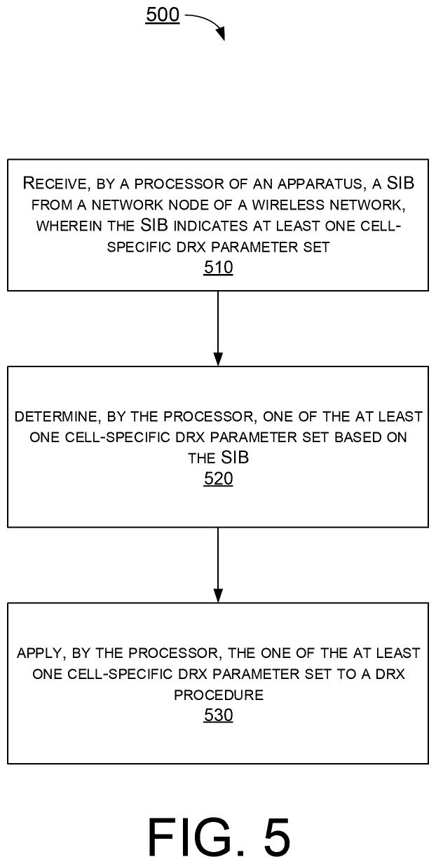

FIG. 5 illustrates an example process 500 in accordance with an implementation of the present disclosure. Process 500 may be an example implementation of above scenarios/schemes, whether partially or completely, with respect to improvement of network energy saving with UE data scheduling. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of communication apparatus 410 receiving a SIB from a network node (e.g., network apparatus 420) of a wireless network, wherein the SIB indicates at least one cell-specific DRX parameter set. Process 500 may proceed from 510 to 520.

At 520, process 500 may involve processor 412 determining one of the at least one cell-specific DRX parameter set based on the SIB. Process 500 may proceed from 520 to 530.

At 530, process 500 may involve processor 412 applying the one of the at least one cell-specific DRX parameter set to a DRX procedure.

In some implementations, process 500 may further involve processor 412 aligning a DRX active time with a cell-specific RS time based on a DRX offset, wherein the DRX offset is configured by the one of the at least one cell-specific DRX parameter set.

In some implementations, the aligning of the DRX active time with the cell-specific RS time based on the DRX offset corresponds to an aggregation of activities of the network node (e.g., network apparatus 420).

In some implementations, process 500 may further involve processor 412 obtaining an indication configured by the SIB. Then, process 500 may further involve processor 412 determining the one of the at least one cell-specific DRX parameter set based on the indication.

In some implementations, process 500 may further involve processor 412 receiving an adaptation configured by a system information update procedure form the network node (e.g., network apparatus 420). Then, process 500 may further involve processor 412 adapting the indication based on the adaptation to determine the one of the at least one cell-specific DRX parameter set.

In some implementations, process 500 may further involve processor 412 obtaining an indication and an adaptation configured by a L1 signaling. Then, process 500 may further involve processor 412 determining the one of the at least one cell-specific DRX parameter set based on the indication and the adaptation.

In some implementations, the L1 signaling comprises at least one of an extended DCI format 2_7, an extended paging DCI, an extended PSS, an extended SSS, and an extended periodic-TRS.

In some implementations, process 500 may further involve processor 412 applying the adaptation according to an application delay.

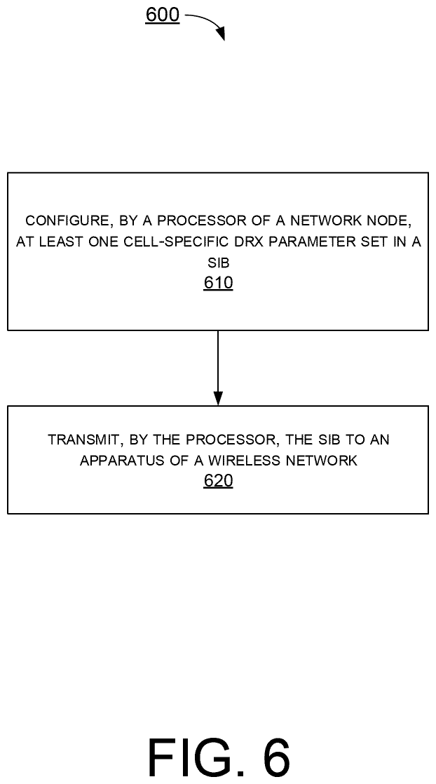

FIG. 6 illustrates an example process 600 in accordance with an implementation of the present disclosure. Process 600 may be an example implementation of above scenarios/schemes, whether partially or completely, with respect to improvement of network energy saving with UE data scheduling. Process 600 may represent an aspect of implementation of features of network apparatus 420. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any suitable BS or network nodes. Solely for illustrative purposes and without limitation, process 600 is described below in the context of network apparatus 420. Process 600 may begin at block 610.

At 610, process 600 may involve processor 422 of network apparatus 420 configuring at least one cell-specific DRX parameter set in a SIB. Process 600 may proceed from 610 to 620.

At 620, process 600 may involve processor 422 transmitting the SIB to an apparatus (e.g., communication apparatus 410).

In some implementations, process 600 may further involve processor 422 aligning a DRX active time with a cell-specific RS time based on a DRX offset, wherein the DRX offset is indicated by the one of the at least one cell-specific DRX parameter set.

In some implementations, process 600 may further involve processor 422 configuring an indication in the SIB to the apparatus (e.g., communication apparatus 410). Then, process 600 may further involve processor 422 configuring an adaptation with a system information update procedure to the apparatus (e.g., communication apparatus 410), wherein the adaptation adapts the indication in the SIB.

In some implementations, process 600 may further involve processor 422 configuring an indication and an adaptation in a L1 signaling to the apparatus (e.g., communication apparatus 410), wherein the L1 signaling comprises at least one of an extended DCI format 2_7, an extended paging DCI, an extended PSS, an extended SSS, and an extended periodic-TRS.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a system information block (SIB) from a network node of a wireless network, wherein the SIB indicates at least one cell-specific discontinuous reception (DRX) parameter set;
determining, by the processor, one of the at least one cell-specific DRX parameter set based on the SIB; and
applying, by the processor, the one of the at least one cell-specific DRX parameter set to a DRX procedure.

2. The method of claim 1, further comprising:
obtaining, by the processor, an indication configured by the SIB; and
determining, by the processor, the one of the at least one cell-specific DRX parameter set based on the indication.

3. The method of claim 2, further comprising:
receiving, by the processor, an adaptation configured by a system information update procedure form the network node; and
adapting, by the processor, the indication based on the adaptation to determine the one of the at least one cell-specific DRX parameter set.

4. The method of claim 1, further comprising:
obtaining, by the processor, an indication and an adaptation configured by a layer 1 (L1) signaling; and
determining, by the processor, the one of the at least one cell-specific DRX parameter set based on the indication and the adaptation.

5. The method of claim 4, wherein the L1 signaling comprises at least one of an extended Downlink Control Information (DCI) format 2_7, an extended paging DCI, an extended primary synchronization signal (PSS), an extended secondary synchronization signal (SSS), and an extended periodic-tracking reference signal (periodic-TRS).

6. The method of claim 4, further comprising:
applying, by the processor, the adaptation according to an application delay.

7. The method of claim 1, further comprising:
aligning, by the processor, a DRX active time with a cell-specific reference signal (RS) time based on a DRX offset, wherein the DRX offset is configured by the one of the at least one cell-specific DRX parameter set.

8. The method of claim 7, wherein the aligning of the DRX active time with the cell-specific RS time based on the DRX offset corresponds to an aggregation of activities of the network node.

9. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a system information block (SIB) from the network node, wherein the SIB indicates at least one cell-specific discontinuous reception (DRX) parameter set;
determining one of the at least one cell-specific DRX parameter set based on the SIB; and
applying the one of the at least one cell-specific DRX parameter set to a DRX procedure.

10. The apparatus of claim 9, wherein, during operation, the processor further performs operations comprising:
obtaining an indication configured by the SIB; and
determining the one of the at least one cell-specific DRX parameter set based on the indication.

11. The apparatus of claim 10, wherein, during operation, the processor further performs operations comprising:
receiving, via the transceiver, an adaptation configured by a system information update procedure form the network node; and
adapting the indication based on the adaptation to determine the one of the at least one cell-specific DRX parameter set.

12. The apparatus of claim 9, wherein, during operation, the processor further performs operations comprising:
obtaining an indication and an adaptation configured by a layer 1 (L1) signaling; and
determining the one of the at least one cell-specific DRX parameter set based on the indication and the adaptation.

13. The apparatus of claim 12, wherein the L1 signaling comprises at least one of an extended Downlink Control Information (DCI) format 2_7, an extended paging DCI, an extended primary synchronization signal (PSS), an extended secondary synchronization signal (SSS), and an extended periodic-tracking reference signal (periodic-TRS).

14. The apparatus of claim 12, wherein, during operation, the processor further performs operations comprising:
applying the adaptation according to an application delay.

15. The apparatus of claim 9, wherein, during operation, the processor further performs operations comprising:
aligning a DRX active time with a cell-specific reference signal (RS) time based on a DRX offset, wherein the DRX offset is configured by the one of the at least one cell-specific DRX parameter set.

16. The apparatus of claim 15, wherein the aligning of the DRX active time with the cell-specific RS time based on the DRX offset corresponds to an aggregation of activities of the network node.

17. A method, comprising:
configuring, by a processor of a network node, at least one cell-specific discontinuous reception (DRX) parameter set in a system information block (SIB); and
transmitting, by the processor, the SIB to an apparatus of a wireless network.

18. The method of claim 17, further comprising:
configuring, by the processor, an indication in the SIB to the apparatus; and
configuring, by the processor, an adaptation with a system information update procedure to the apparatus, wherein the adaptation adapts the indication in the SIB.

19. The method of claim 17, further comprising:
configuring, by the processor, an indication and an adaptation in a layer 1 (L1) signaling to the apparatus, wherein the L1 signaling comprises at least one of an extended Downlink Control Information (DCI) format 2_7, an extended paging DCI, an extended primary synchronization signal (PSS), an extended secondary synchronization signal (SSS), and an extended periodic-tracking reference signal (periodic-TRS).

20. The method of claim 17, further comprising:
aligning, by the processor, a DRX active time with a cell-specific reference signal (RS) time based on a DRX offset, wherein the DRX offset is indicated by the one of the at least one cell-specific DRX parameter set.
